(19) United States
(12) Patent Application Publication
(10) Pub. No.: US 2009/0033470 A1
(43) Pub. Date: Feb. 5, 2009

(54) APPARATUS FOR ROBOT BEHAVIOR SERIES CONTROL BASED ON RFID TECHNOLOGY

(75) Inventors: Li-Dien Fu, Kinmen County (TW); Tung-Hung Lu, Yilan County (TW)

Correspondence Address: WPAT, PC, 7225 BEVERLY ST., ANNANDALE, VA, 22003, US

(73) Assignee: INDUSTRIAL TECHNOLOGY RESEARCH INSTITUTE, Hsin-Chu (TW)

(21) Appl. No.: 11/966,647

(22) Filed: Dec. 28, 2007

(30) Foreign Application Priority Data
Jul. 31, 2007 (TW) 96127905

(51) Int. Cl. H04Q 5/22

(52) U.S. Cl. 340/10.4; 340/10.1; 340/539.1

(57) ABSTRACT

A method for robot behavior series control based on radio frequency identification (RFID) technology, and which is with capability of extending behaviors by composing or arranging different behavior units series in RFID tags. The apparatus comprises: an RFID reader, for accessing data stored in an RFID tag; a behavior control unit, capable of receiving data from the RFID tag while decoding and converting the received data into corresponding behavior code to be outputted and used for controlling behaviors of a robot; a driving unit, for receiving the output from the behavior control unit so as to actuate the robot to generate interactions with an accessory of the robot where the RFID tag is attached thereon.

### BACKGROUND OF THE INVENTION

1. Field of the Invention

The present invention generally relates to an apparatus for robot behavior series control based on radio-frequency identification (RFID) technology and, more particularly, to an apparatus wherein a robot is equipped with an RFID reader to access data in an RFID tag attached to an associated accessory and transmit the data to a behavior control unit capable of selecting a corresponding behavior mode from a behavior database so that a driving unit actuates the robot to interact with the accessory according to the behavior mode.

2. Description of the Prior Art

The conventional electronic pet can only move and/or sound without interactions with the user; and therefore the user often gets bored with it in a very short time, which leads to the birth of interactive electronic pets.

The interactive electronic pets originated in 1996 when Japanese Bandai invented Tamagotchi, which is an interactive small-size gamer, with a flat panel display (FPD), simulating a chicken from incubation to death. Tamagotchi attracted people from kids to the working class so much that it was announced that the robot era had begun. With the development in electronics-based technology, SONY marketed AIBO, which is an electronic puppy with a gear drive, a speech module and a detector to detect external images and sound to interact with the user. However, such a product is manufactured with high cost so that the general consumers cannot afford it.

Therefore, there is need in providing a relatively low-cost interactive product with artificial intelligent based on RFID technology.

### SUMMARY OF THE INVENTION

It is an object of the present invention to provide an apparatus for robot behavior series control based on RFID technology, wherein a robot is equipped with an RFID reader to access data in an RFID tag attached to an associated accessory and transmit the data to a behavior control unit capable of selecting a corresponding behavior mode from a behavior database so that a driving unit actuates the robot to interact with the accessory according to the behavior mode.

It is another object of the present invention to provide an apparatus for robot behavior series control based on RFID technology, wherein the behavior database is updated using The Internet, a storage medium and a programming interface. For example, the character of an electronic puppy can be changed from shyness to vigorousness by updating the behavior database so that the user feels more excited about the electronic puppy and keeps its fondness for it.

In order to achieve the foregoing objects, the present invention provides an apparatus for robot behavior series control based on RFID technology, wherein an RFID tag is attached to an accessory, the apparatus comprising: an RFID reader, capable of accessing data stored in the RFID tag; a behavior control unit, capable of receiving the data from the RFID tag while decoding and converting the received data into corresponding behavior codes to be output; and a driving unit, capable of receiving the output from the behavior control unit so as to actuate the robot to generate interactions with the accessory corresponding to the robot.

In order to achieve the foregoing objects, the present invention further provides an apparatus for robot behavior series control based on RFID technology, the apparatus comprising: an RFID reader, capable of accessing data stored in an RFID tag; a behavior control unit, capable of receiving the data from the RFID tag while decoding and converting the received data into corresponding behavior codes to be output; a wireless transmitting interface, capable of wirelessly transmitting the output from the behavior control unit to the external; a wireless receiving interface, capable of receiving and reproducing the output from the wireless transmitting interface; and a driving unit, capable of receiving the output from the wireless receiving interface so as to actuate the robot to generate interactions with an accessory corresponding to a robot.

### BRIEF DESCRIPTION OF THE DRAWINGS

The objects, spirits and advantages of the preferred embodiment of the present invention will be readily understood by the accompanying drawings and detailed descriptions, wherein:

FIG. 1 is a schematic functional block diagram showing an RFID reader disposed external to an electronic robot with a wireless interference for transmitting a driving command into the inner part of the robot according to the present invention;

FIG. 2 is a schematic functional block diagram showing a RFID reader disposed inside an electronic robot to directly actuate the robot according to the present invention;

FIG. 3 is a schematic functional block diagram showing a software configuration according to the present invention;

FIG. 4 is a detailed functional block diagram showing a software configuration in FIG. 3;

FIG. 5A shows the data stored in the RFID tag received by the behavior control unit arranged in a serial format according to a first embodiment of the present invention;

FIG. 5B shows the data stored in the RFID tag received by the behavior control unit arranged in a serial format according to a second embodiment of the present invention; and

FIG. 6 is a schematic diagram showing how a behavior database is updated according to the present invention.

### DETAILED DESCRIPTION OF THE PREFERRED EMBODIMENT

The present invention can be exemplified by the preferred embodiments as described hereinafter.

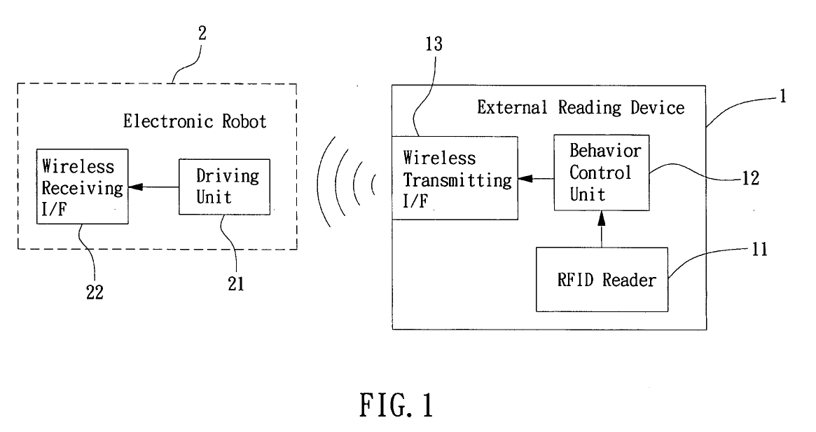

Please refer to FIG. 1, which is a schematic functional block diagram showing an RFID reader disposed external to an electronic robot with a wireless interference for transmitting a driving command into the inner part of the robot according to the present invention. In the present embodiment, the electronic robot is a general electronic pet such as an electronic puppy, and an electronic cat. Those with ordinary skills in the art can make modifications to widen the applications of the robot as a toy (an electronic pet), for home applications (for example, a cleaning robot), for business applications (for example, for use in an office), or industry applications (for example, for use in manufacturing). In the present embodiment, the electronic robot is an electronic puppy wearing on its back an external reading device 1 (which looks like a backpack or a dress). The external reading device 1 comprises an RFID reader 11 capable of reading data stored in an RFID tag (not shown); a behavior control unit 12, capable of receiving the data from the RFID tag while decoding and converting the received data into corresponding behavior codes to be output in a serial format; and a wireless transmitting interface 13 capable of wirelessly transmitting the output from the behavior control unit 12 to the external. The wireless transmitting interface 13 is an infrared interface, a Bluetooth interface or an RF interface. The RFID tag and the RFID reader operate at a high frequency, an ultra-high frequency, an active high frequency or an active ultra-high frequency.

The robot 2; a wireless receiving interface, capable of receiving and reproducing the output from the wireless transmitting interface; and a driving unit, capable of receiving the output from the wireless receiving interface so as to actuate the robot to generate interactions with an accessory corresponding to a robot.

The robot 2 comprises a wireless receiving interface 22 and a driving unit 21. The wireless receiving interface 22 receives and reproduce the output from the wireless transmitting interface 13. The wireless receiving interface 22 is an infrared interface, a Bluetooth interface or an RF interface matching with the wireless receiving interface 22. The driving unit 21 receives the output from the wireless receiving interface 22 and actuate the robot to react with the accessory corresponding to the robot (such as a dog bone, a wire pole, a gun, etc). For example, an electronic puppy waves its tail to show the happiness when it sees a dog bone (actually, senses a specific motion of the RFID tag); an electronic puppy lifts its hind leg to hold a pissing pose when it sees a wire pole; and an electronic puppy turns upside down to play dead when it sees a gun. In the present invention, the RFID reader can be installed either inside or external to the electronic puppy. The aforementioned interactions generated by the driving unit comprise driving a gear drive (for the extremities, the neck, or the tail), a speech module (for barking) or a lighting module (for the eyes) to simulate the diversified behaviors of the electronic pet.

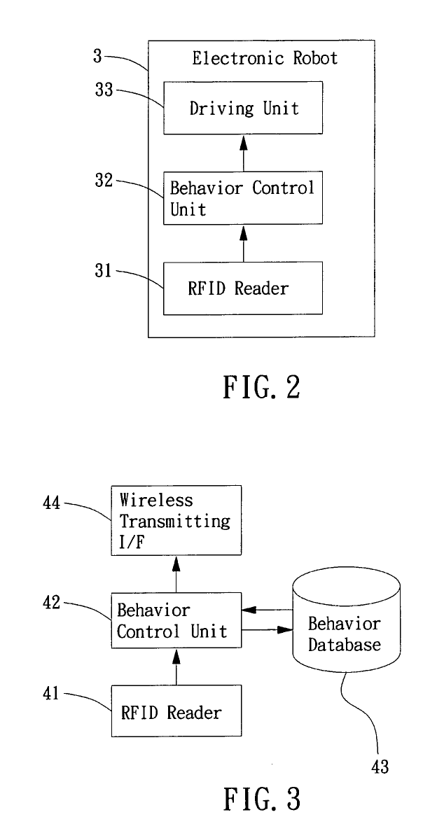

Please refer to FIG. 2, which a schematic functional block diagram showing a RFID reader disposed inside an electronic robot to directly actuate the robot according to the present invention. Compared to the configuration in FIG. 1, the configuration in FIG. 2 is characterized in that the RFID reader 31 is disposed inside the robot 3. The data read by the RFID reader 31 is transmitted to the behavior control unit 32 to interpret the content of the RFID and convert the content of the RFID into corresponding behavior codes to be output to the driving unit 33. The robot 3 is then actuated to react with the associated accessory. In this manner, compared to the disclosure in FIG. 1, optimal driving performance (with reduced delay time for the wireless interface to transmit a signal) can be achieved with lowered cost of the robot 3.

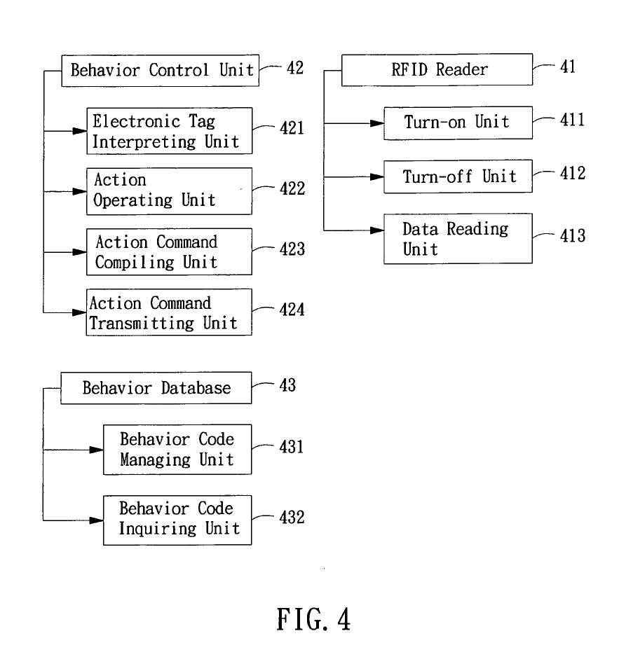

Please refer to FIG. 3 and FIG. 4, which show a schematic functional block diagram and a detailed functional block diagram of a software configuration according to the present invention. The software configuration comprises a RFID reader 41, a behavior control unit 42, a behavior database 43 and a wireless transmitting interface 44, which are individually described in detail as follows:

(1) The behavior control unit 42 comprises:
an electronic tag interpreting unit 421, capable of interpreting the data stored in the RFID tag and compiling the data in an action command format to be output;
an action operating unit 422, capable of receiving and performing operation on the action command format output so as to output in a text format from the electronic tag interpreting unit 421;
an action command compiling unit 423, capable of receiving the output from the action operating unit 422 and obtaining the behavior codes corresponding to the different actions from the behavior database so as to output the behavior codes in series; and
an action command transmitting unit 424, capable of writing the corresponding behavior codes output from the action command compiling unit 423 into an I/O port of the driving unit.

(2) The RFID reader 41 comprises:
a turn-on unit 411, capable of turning on the RFID reader 41, wherein the turn-on unit 411 operates in a full-time mode, a set-time mode or a real-time mode;
a turn-off unit 412, capable of turning off the RFID reader 41; and
a data reading unit 413, capable of reading the data stored in the RFID tag and verifying the effectiveness of the data.

(3) The behavior database 43 comprises:
a behavior code managing unit 431, capable of generating a common behavior control corresponding to different robots by comparing the behavior codes to different actions; and
a behavior code inquiring unit 432, capable of inquiring the behavior codes; wherein the behavior codes comprise the delay time required for the behavior control unit to react.

(4) The wireless transmitting interface 44 is an infrared interface, a Bluetooth interface or an RF interface. However, the present invention is not limited thereto.

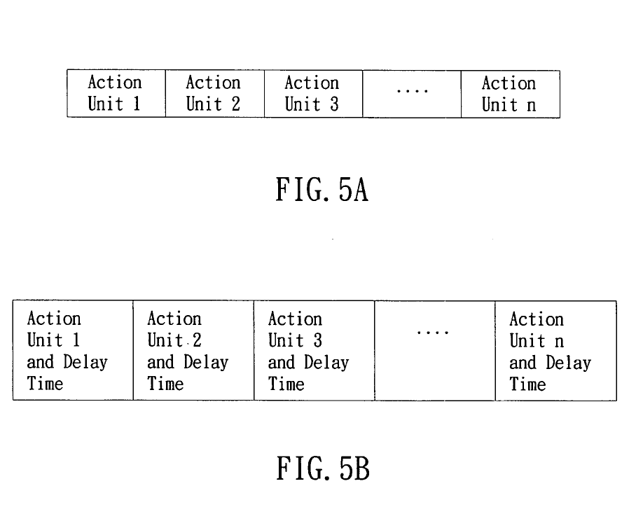

Please refer to FIG. 5A and FIG. 5B, which shows the data stored in the RFID tag received by the behavior control unit arranged in a serial format according to a first and a second embodiments of the present invention. The data in the RFID tag is converted into an action unit arranged in a serial format after the behavior control unit received the data stored in the RFID tag. In FIG. 5A, the action unit is arranged in a serial format, wherein adjacent behavior codes are executed in a successive manner. For example, action unit 1 for an electronic puppy means stand-up, action unit 2 means sit-down, action unit 3 means lift-up of a front leg, etc. In FIG. 5B, the action unit is also arranged in a serial format. In addition, the delay time is added up to the action unit. For example, action unit 1 for an electronic puppy means stand-up. After one second, action unit 2 is executed to indicate sit-down. After three seconds, action unit 3 is executed to indicate lift-up of a front leg. After two seconds, action unit 4 is executed, etc. FIG. 5B shows a preferred embodiment, wherein the robot performs smoothly in a successive manner to achieve optimal results.

The aforementioned action unit is a combination of a plurality of behavior codes. Each represents a single action, and therefore the combination of a plurality of behavior codes forms an action unit. For example, action unit A is for an electronic puppy to prostrate itself, which comprises a behavior code for bending two hind legs and then a behavior code for bending two front legs. Action unit B is for an electronic puppy to sit down, which only comprises a single behavior code for bending two hind legs. With different combinations of behavior codes, the electronic robot performs different behaviors. Accordingly, new interaction models can be created without changing the structure of a robot and the behavior data thereof. As a result, low-cost RFID tags can be commercially used to produce low-cost interactive products (such as dog bones, flying discs) with respective series of behavior codes written therein.

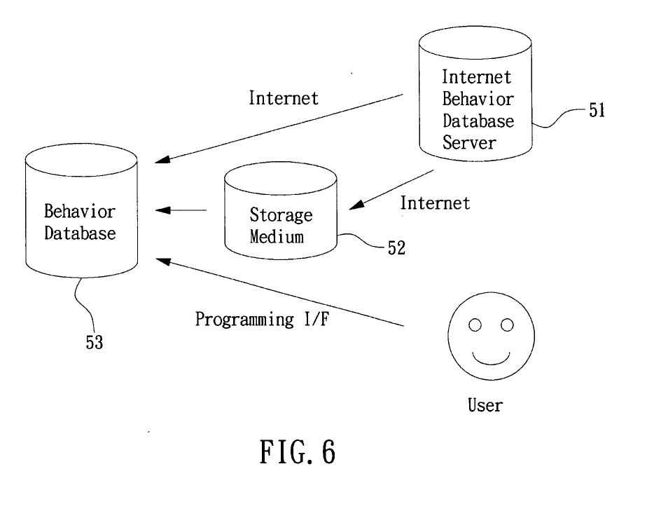

Please refer to FIG. 6, which is a schematic diagram showing how a behavior database is updated according to the present invention. The behavior database 53 is updated from an Internet behavior database server 51 through the Internet, a storage medium 52 (such as a portable disc or other simple-and-easy-to-use storage device) or a program editing interface. The storage medium 52 downloads and stores the updated data and then stores the data to the robot behavior database 53. The program editing interface provides a plurality of pre-determined behavior codes so that the user only has to selects a preferred option (such as shyness, vigorousness, gratification, etc). For example, the character of an electronic puppy can be changed from shyness to vigorousness by updating the behavior database so that the user feels more excited about the electronic puppy and keeps its fondness for it.

From FIG. 1 to FIG. 6, it is understood that the present invention provides an apparatus for robot behavior series control based on RFID technology, wherein a robot is equipped with an RFID reader to access data in an RFID tag attached to an associated accessory and transmit the data to a behavior control unit capable of selecting a corresponding behavior mode from a behavior database so that a driving unit actuates the robot to interact with the accessory according to the behavior mode. Therefore, the present invention is new, useful and non-obvious.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. An apparatus for robot behavior series control based on radio frequency identification (RFID) technology, wherein an RFID tag is attached to an accessory corresponding to a robot, the apparatus comprising:
an RFID reader, capable of accessing data stored in the RFID tag;
a behavior control unit, capable of receiving the data from the RFID tag while decoding and converting the received data into corresponding behavior codes to be output; and
a driving unit, capable of receiving the output from the behavior control unit so as to actuate the robot to generate interactions with the accessory corresponding to the robot.

2. The apparatus for robot behavior series control based on RFID technology as recited in claim 1, wherein the apparatus further comprises a behavior database.

3. The apparatus for robot behavior series control based on RFID technology as recited in claim 2, wherein the behavior database further comprises:
a behavior code managing unit, capable of generating a common behavior control corresponding to different robots by comparing the behavior codes to different actions; and
a behavior code inquiring unit, capable of inquiring the behavior codes.

4. The apparatus for robot behavior series control based on RFID technology as recited in claim 3, wherein the behavior codes comprise the delay time required for the behavior control unit to react.

5. The apparatus for robot behavior series control based on RFID technology as recited in claim 2, wherein the behavior database is updated through the Internet, a storage medium or a program editing interface.

6. The apparatus for robot behavior series control based on RFID technology as recited in claim 1, wherein the behavior control unit further comprises:
an electronic tag interpreting unit, capable of interpreting the data stored in the RFID tag and compiling the data in an action command format to be output;
an action operating unit, capable of receiving and performing operation on the action command format output so as to output in a text format;
an action command compiling unit, capable of receiving the output from the action operating unit and obtaining the behavior codes corresponding to the different actions from the behavior database so as to output the behavior codes in series; and
an action command transmitting unit, capable of writing the corresponding behavior codes output from the action command compiling unit into an I/O port of the driving unit.

7. The apparatus for robot behavior series control based on RFID technology as recited in claim 1, wherein the RFID reader further comprises:
a turn-on unit, capable of turning on the RFID reader;
a turn-off unit, capable of turning off the RFID reader; and
a data reading unit, capable of reading the data stored in the RFID tag and verifying the effectiveness of the data.

8. The apparatus for robot behavior series control based on RFID technology as recited in claim 7, wherein the turn-on unit operates in a full-time mode, a set-time mode or a real-time mode.

9. The apparatus for robot behavior series control based on RFID technology as recited in claim 1, wherein the interactions generated by the driving unit comprise driving a gear drive, a speech module or a lighting module.

10. The apparatus for robot behavior series control based on RFID technology as recited in claim 1, wherein the robot is used as a toy or for home applications, business applications or industry applications.

11. The apparatus for robot behavior series control based on RFID technology as recited in claim 1, wherein the RFID tag operates at a high frequency, an ultra-high frequency, an active high frequency or an active ultra-high frequency.

12. The apparatus for robot behavior series control based on RFID technology as recited in claim 1, wherein the RFID reader operates at a high frequency, an ultra-high frequency, an active high frequency or an active ultra-high frequency.

13. The apparatus for robot behavior series control based on RFID technology as recited in claim 1, wherein the data received by the behavior control unit is converted into an action unit in a serial format.

14. The apparatus for robot behavior series control based on RFID technology as recited in claim 13, wherein the action unit comprises a plurality of behavior codes.

15. An apparatus for robot behavior series control based on radio frequency identification (RFID) technology, the apparatus comprising:
an RFID reader, capable of accessing data stored in an RFID tag;
a behavior control unit, capable of receiving the data from the RFID tag while decoding and converting the received data into corresponding behavior codes to be output;
a wireless transmitting interface, capable of wirelessly transmitting the output from the behavior control unit to the external;
a wireless receiving interface, capable of receiving and reproducing the output from the wireless transmitting interface; and
a driving unit, capable of receiving the output from the wireless receiving interface so as to actuate the robot to generate interactions with an accessory corresponding to a robot.

16. The apparatus for robot behavior series control based on RFID technology as recited in claim 15, wherein the wireless transmitting interface is an infrared interface, a Bluetooth interface or an RF interface.

17. The apparatus for robot behavior series control based on RFID technology as recited in claim 15, wherein the wireless receiving interface is an infrared interface, a Bluetooth interface or an RF interface.

18. The apparatus for robot behavior series control based on RFID technology as recited in claim 15, wherein the apparatus further comprises a behavior database.

19. The apparatus for robot behavior series control based on RFID technology as recited in claim 18, wherein the behavior database further comprises:
a behavior code managing unit, capable of generating a common behavior control corresponding to different robots by comparing the behavior codes to different actions; and
a behavior code inquiring unit, capable of inquiring the behavior codes.

20. The apparatus for robot behavior series control based on RFID technology as recited in claim 19, wherein the behavior codes comprise the delay time required for the behavior control unit to react.

21. The apparatus for robot behavior series control based on RFID technology as recited in claim 18, wherein the behavior database is updated through the Internet, a storage medium or a program editing interface.

22. The apparatus for robot behavior series control based on RFID technology as recited in claim 15, wherein the behavior control unit further comprises:
an electronic tag interpreting unit, capable of interpreting the data stored in the RFID tag and compiling the data in an action command format to be output;
an action operating unit, capable of receiving and performing operation on the action command format output so as to output in a text format;
an action command compiling unit, capable of receiving the output from the action operating unit and obtaining the behavior codes corresponding to the different actions from the behavior database so as to output the behavior codes in series; and
an action command transmitting unit, capable of writing the corresponding behavior codes output from the action command compiling unit into an I/O port of the driving unit.

23. The apparatus for robot behavior series control based on RFID technology as recited in claim 15, wherein the RFID reader further comprises:
a turn-on unit, capable of turning on the RFID reader;
a turn-off unit, capable of turning off the RFID reader; and
a data reading unit, capable of reading the data stored in the RFID tag and verifying the effectiveness of the data.

24. The apparatus for robot behavior series control based on RFID technology as recited in claim 23, wherein the turn-on unit operates in a full-time mode, a set-time mode or a real-time mode.

25. The apparatus for robot behavior series control based on RFID technology as recited in claim 15, wherein the interactions generated by the driving unit comprise driving a gear drive, a speech module or a lighting module.

26. The apparatus for robot behavior series control based on RFID technology as recited in claim 15, wherein the robot is used as a toy or for home applications, business applications or industry applications.

27. The apparatus for robot behavior series control based on RFID technology as recited in claim 15, wherein the RFID tag operates at a high frequency, an ultra-high frequency, an active high frequency or an active ultra-high frequency.

28. The apparatus for robot behavior series control based on RFID technology as recited in claim 15, wherein the RFID reader operates at a high frequency, an ultra-high frequency, an active high frequency or an active ultra-high frequency.

29. The apparatus for robot behavior series control based on RFID technology as recited in claim 15, wherein the data received by the behavior control unit is converted into an action unit in a serial format.

30. The apparatus for robot behavior series control based on RFID technology as recited in claim 29, wherein the action unit comprises a plurality of behavior codes.
